(19) United States
(12) Patent Application Publication
(10) Pub. No.: US 2012/0061342 A1
(43) Pub. Date: Mar. 15, 2012

(54) GLASS CONTAINER AND A CORRESPONDING MANUFACTURING METHOD

(76) Inventor: Carine Perrot, Etalondes (FR)

(21) Appl. No.: 13/231,550

(22) Filed: Sep. 13, 2011

(30) Foreign Application Priority Data
Sep. 13, 2010 (FR) 1057290

(51) Int. Cl. B65D 23/08; C03C 17/00; B05D 1/18; B05D 5/00; B05D 3/02

(52) U.S. Cl. 215/12.2; 427/287; 427/314

(57) ABSTRACT

The invention relates to method of manufacturing a container (1) designed to contain at least one product, preferably a foodstuff, said container (1) having a glass wall (2) made up of an inside face (3) designed to be in contact with said at least one product, and of an outside face (4) that is opposite from said inside face, said method being characterized in that it includes a coating step for covering at least a fraction of said outside face (4) with a coating (8) including at least a silicone and being designed to impart resistance-to-breakage properties to said glass wall (2), said coating step including a dipping step, said method further comprising, prior to the dipping step, a step of pre-heating the container (1), wherein the glass is preferably pre-heated to a temperature lying in the range from 200° C. to 250° C.

The present invention relates to the general field of containers provided with glass surfaces and usable in various industrial sectors, and in particular for packaging made of glass, e.g. in the cosmetics, pharmaceutical, or food fields.

The invention also relates to the technical field of treating glass containers for functional and/or decorative purposes, in particular treating containers serving to receive food as their contents.

The invention relates more precisely to a container designed to contain at least one human or animal foodstuff, said container having a glass wall made up of an inside face designed to be in contact with said at least one foodstuff, and of an outside face that is opposite from said inside face.

The invention also relates to a method of manufacturing, and more particularly of coating, a container of any kind, and more particularly a glass container suitable for cosmetics, pharmaceutical, or food packaging.

The invention more particularly relates to a method of manufacturing, and more particularly of coating, a container designed to contain at least one human or animal foodstuff, said container having a glass wall made up of an inside face designed to be in contact with said at least one foodstuff, and of an outside face that is opposite from said inside face.

Baby's bottles made of plastics materials and for feeding babies, infants, and very young children are in common and quite widespread use in the world. Such baby's bottles, usually filled with a liquid such as milk, offer the main advantage of being unbreakable and of having good mechanical strength in terms of ability to withstand falls or impacts, unlike the glass baby's bottles that used to be used.

In addition, such plastic baby's bottles are particularly light in weight, resistant to temperature variations, in particular while they are being washed (in a dishwasher), and while they are being disinfected (sterilized). In addition, they are designed with very varied dimensions, shapes, and models, making them particularly practical and aesthetically pleasing. There also exist baby's bottles of ergonomic shape making them easier for parents to handle or for young children to hold in their hands.

However, even though they offer non-negligible advantages, such baby's bottles made of plastics materials also suffer from certain drawbacks.

Most plastic baby's bottles contain bisphenol A (BPA), a chemical compound that is used to a large extent in manufacturing plastics such as polycarbonate that forms part of the composition used to make baby's feed bottles and water dispenser bottles. BPA, which is very useful and for which it is difficult to find a substitute, is also used in the manufacture of numerous polyvinyl chlorides (PVCs) and linings of metal cans for preserving food or beverages.

However, it has been shown that BPA might be a particularly toxic compound, and in particular that it might have consequences for human reproduction, when repeatedly ingested by children. BPA tends to leach out spontaneously into the infant's milk while the baby's bottle is being used, in particular after said bottle has been washed at a high temperature or with powerful detergents. BPA contamination can also occur through inhalation or through contact with the skin.

In view of the adverse effects of BPA and in view of it recently being banned from use in making bottles for babies in certain countries, increasing use is being made of baby's bottles made of glass for feeding babies. Such glass baby's bottles are totally innocuous and offer the advantage of not containing any BPA. Glass also offers the advantage of not containing any phthalates and of being 100% recyclable. Glass baby's bottles are also easy to clean insofar as they generally withstand the thermal shock generated, in particular, by dishwasher washing and by sterilization.

Unfortunately, such glass baby's bottles suffer from certain drawbacks that can sometimes limit their use.

Glass baby's bottles are fragile when subjected to impacts, or falls, and they can thus easily be broken. It is particularly dangerous if a glass baby's bottle breaks insofar as such breakage gives rise to a large number of sharp fragments of all sizes that might cause cuts or serious consequences in the event of being ingested by a child.

The objects assigned to the invention are thus to remedy the above-mentioned drawbacks and to propose a novel container that offers good mechanical strength, and in particular that withstands breakage, and that is particularly safe in terms of toxicity and innocuousness.

Another object of the invention is to propose a novel container that is particularly strong and stable, in particularly chemically, regardless of the conditions under which it is used, in particular in the event of thermal shock or in the event of mechanical impacts, or in the event of a change in humidity conditions or the presence of liquid water.

Another object of the invention is to propose a novel container that presents aesthetically pleasing characteristics that are particularly attractive to the user.

Another object of the invention is to propose a novel container that comprises ingredients that are safe, resistant to the constraints of use, readily available, and non-toxic.

Another object of the invention is to propose a novel container that can be used for feeding infants.

Another object of the invention is to propose a novel method of manufacturing a container that comprises steps that are controlled, in such a manner as to obtain a container that withstands breakage and that is particularly safe in terms of toxicity and innocuousness.

Another object of the invention is to propose a novel method of manufacturing a container that comprises steps that are reliable, making it possible to obtain properties that are reproducible.

The objects assigned to the invention are achieved by means of a container designed to contain at least one product, preferably a human or animal foodstuff, said container having a glass wall made up of an inside face designed to be in contact with said at least one product, and of an outside face that is opposite from said inside face, said container being characterized in that at least a fraction of said outside face of said container is covered with a coating obtained by a dipping method, said coating including at least a silicone and being designed to impart resistance-to-breakage properties to said glass wall.

The objects assigned to the invention are also achieved by means of a method of manufacturing a container designed to contain at least one product, preferably a human or animal foodstuff, said container having a glass wall made up of an inside face designed to be in contact with said at least one foodstuff, and of an outside face that is opposite from said inside face, said method being characterized in that it includes a coating step for covering at least a fraction of said outside face with a coating including at least a silicone and being designed to impart resistance-to-breakage properties to said glass wall, said coating step including a dipping step.

Other objects and advantages of the invention appear more clearly on reading the following description, and on examining the examples and the accompanying drawings that are given merely by way of non-limiting example and in which:

FIG. 1 is a diagrammatic elevation view of a container of the invention that, in this example, is constituted by a baby's bottle designed to be filled with infant milk;

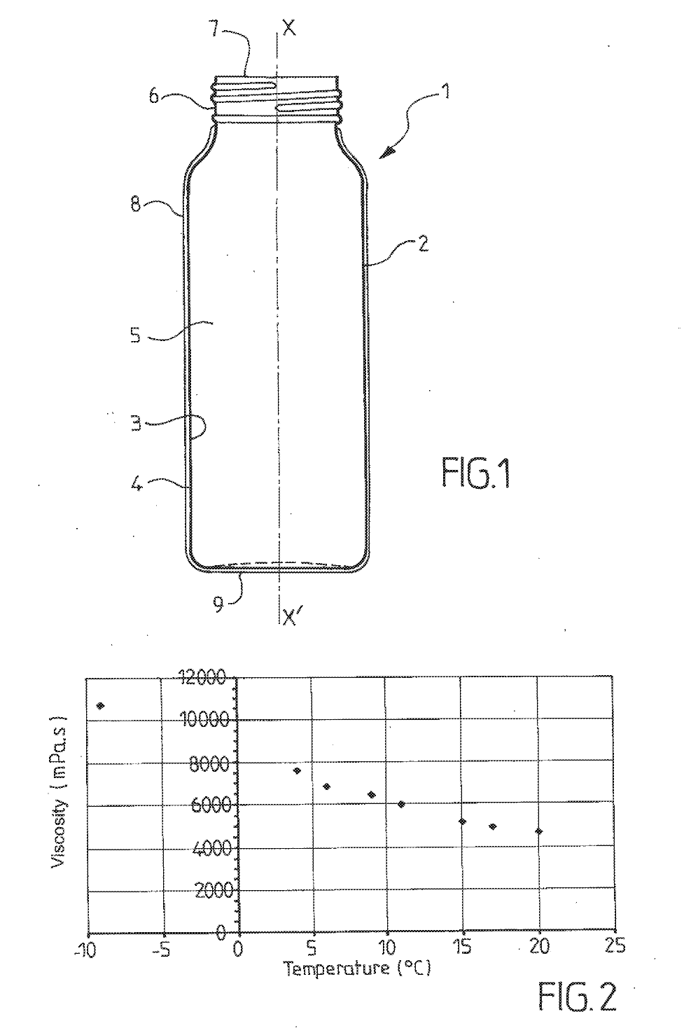

FIG. 2 is a graph showing how the viscosity of the silicone used for coating the container of the invention varies as a function of temperature;

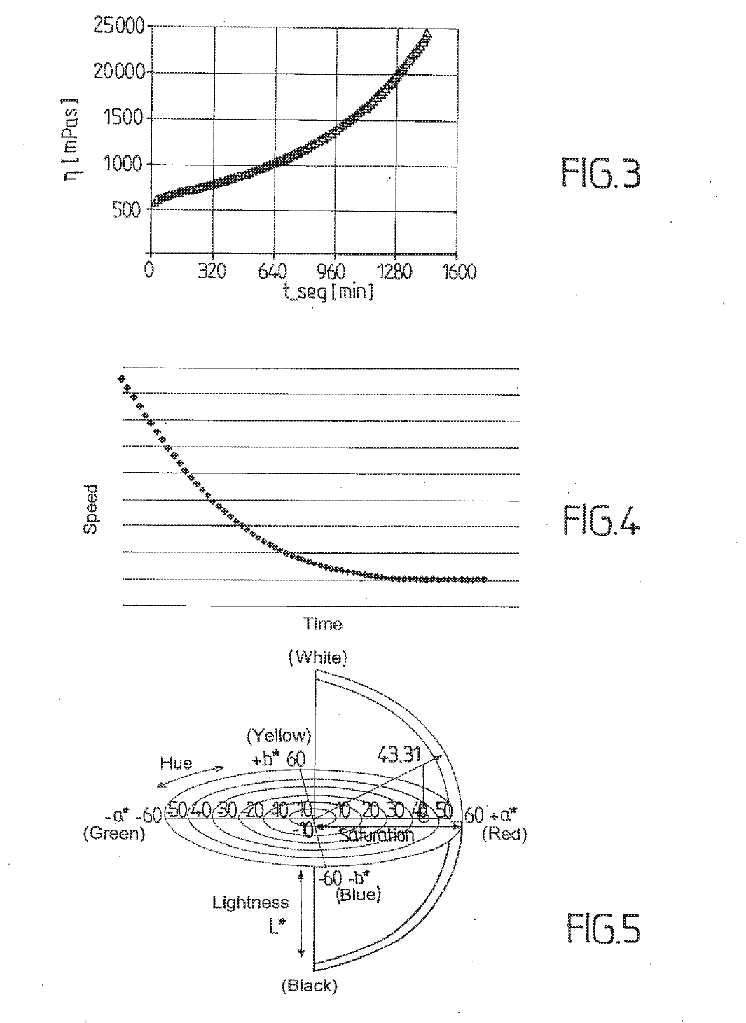

FIG. 3 is a graph showing how the pot life of the silicone used for coating the container of the invention varies as a function of time, at a temperature of 10° C.;

FIG. 4 is a graph showing a profile for the speed at which the container of the invention is removed from the dipping bath; and

FIG. 5 is a color representation model developed by the International Commission on Illumination (CIE, Commission Internationale de l'Eclairage) in 1976.

The invention relates to a container 1 designed to contain at least one product, preferably a human or animal foodstuff, i.e. a container, preferably a food container, of the can, flask, or bottle type, or of some other type. Preferably, the container 1 is closed by a stopper (not shown) in a manner such as to keep its contents inside the container 1, said contents being preferably for consumption by an animal or by a human.

As mentioned above, the container 1, and the corresponding method, may be suitable for packaging other types of products, such as pharmaceutical or cosmetic substances.

Thus, the invention is not limited to a particular embodiment, as the method may be implemented for making many kinds of glass containers 1, of the can, flask, bottle or light bulb type, wherein resistance-to-breakage properties are desired, such containers possibly being suitable for containing products in various forms (liquid, paste, gel, cream, aggregate, flakes, gaseous compound, etc.), of various chemical nature, such as pharmaceutical, cosmetic or detergent substances or compositions, etc.

The container 1 has a glass wall 2 made up of an inside face 3 designed to be in contact with said at least one product/foodstuff and of an outside face 4 opposite from said inside face, as shown in FIG. 1. Advantageously, the container 1 has a main body 5 that stands via its bottom 9 on a surface and that narrows at its top end to form a neck 6 or a ring 6, via which the product/foodstuff is inserted into and extracted from the container 1 through an opening 7. Preferably, the wall 2 of the body 5 and of the neck 6 is made substantially entirely of glass.

In a particularly preferred embodiment, the container 1 constitutes a glass baby's bottle 1 for feeding infants, the body 5 and the neck 6 of the bottle being shown in FIG. 1. For mere reasons of clarity and conciseness, the remainder of the description advantageously describes this embodiment of the container 1 in the preferred form of a baby's bottle 1, in relation with a product forming a foodstuff, without the invention being limited thereto.

The baby's bottle 1 is designed to receive the foodstuff in liquid form, e.g. milk, soup, water, and any other liquid contents that might be fed to an infant. The baby's bottle 1 also has a teat and a stopper that are not shown and that are designed to enable the substantially liquid foodstuff to be fed to the infant and to keep the baby's bottle 1 closed.

Preferably, said glass wall 2 comprises a glass designed to withstand sudden variations in temperature, it being possible for said temperature to vary over a range lying substantially from −20° C. to 100° C., and preferably over a range lying substantially from −10° C. to 95° C.

The glass of the wall 2 is thus suitable for withstanding large variations in temperature, e.g. while the baby's bottle 1 is being heated in a microwave oven or in a double boiler or “bain-marie” or in a saucepan of water, while it is being washed in a dishwasher, or while it is being disinfected by sterilization. In particular, the glass of the wall 2 is advantageously treated with tin oxide while hot, which gives it particularly high resistance to thermal shock.

In addition, said glass wall 2 of the baby's bottle 1 preferably comprises a glass that is neutral through to its core and that is suitable for being in contact with food. In other words, the glass used for manufacturing the baby's bottle 1 is a glass of the borosilicate type that is particularly strong and that advantageously satisfies the requirements for packaging cosmetics and pharmaceuticals. It is a glass that has no influence on the pH and on the chemical nature of the foodstuff contained in the baby's bottle 1, i.e. it does not leach out any of its ingredients and does not react with the foodstuff.

In order to satisfy the various requirements as well as possible, in particular in terms of thermal strength, the glass wall 2 of the baby's bottle 1 advantageously comprises Pyrex or a type I glass.

This type I glass or Pyrex glass also has low alumina content and improved neutrality. The glass used for manufacturing the baby's bottle 1 is thus particularly strong, resistant, stable, and neutral. In addition, it is non-toxic and safe from the health and safety standpoint.

In addition, the glass for the baby's bottle 1 of the invention may advantageously be decorated or bear indications useful for using it, e.g. a graduated scale for measuring the content of the baby's bottle 1. Any type of decoration or the like that is conventionally present on the baby's bottle 1, in particular on the outside face 4 thereof, for reasons of aesthetically pleasing appearance and/or of providing information, may advantageously be added to said glass wall 2.

At least a fraction of said outside face 4 of said container 1 is covered with a coating 8 obtained by a dipping method, said coating 8 including at least a silicone and being designed to impart resistance-to-breakage properties to said glass wall.

In other words, the outside face 4 of the baby's bottle 1 is surrounded by a protective coating 8 forming a protective casing for protecting the bottle from any impacts or from any falls that might be suffered accidentally by the baby's bottle 1, in such a manner as to reduce the risks of the baby's bottle 1 fracturing or breaking into pieces. Preferably, said silicone-based coating 8 is also designed to keep any fragments of glass inside the baby's bottle 1 in the event that repeated impacts do nevertheless break the glass wall 2. The coating 8 forms a protective layer that advantageously acts to restrain any glass fragments in the event of the baby's bottle 1 breaking, so as to avoid the risks of splinters of glass landing on the floor or the risks of accidental cuts.

Preferably, said coating 8 covers substantially the entire outside face 4 of said container 1. The coating 8 is preferably retained in permanent and stable manner on the outside face 4, substantially at every point thereof, so that it is an integral part of the glass wall 2 and so that it cannot be easily detached therefrom. Advantageously, the silicone-based coating 8 adheres to the wall 2 of the bottle, without any gap between said wall and said coating 8, so that no dirt or micro-organism can penetrate and possibly develop between the wall 2 and the coating 8. Such application of the silicone coating 8 against the wall 2 thus guarantees that the coating is reliable over time, innocuousness, and food safe.

This coating 8 is obtained by dipping or soaking the baby's bottle 1 in a fluid, i.e. by immersing the baby's bottle 1 in a substantially liquid bath containing the ingredients of the coating 8 and in particular silicone so that the silicone is in contact with the entire outside face 4 of the baby's bottle and so that it can form a homogeneous one-piece coating over the outside face 4 of the baby's bottle 1.

Silicone is chosen so as to guarantee strength, innocuousness, food contact, and safety for the baby's bottle 1.

Advantageously, the coating 8 is designed to withstand temperatures that can vary over a range lying substantially from −20° C. to 100° C., and preferably over a range lying substantially from −10° C. to 95° C. The coating 8 is preferably designed to withstand sudden and irregular variations in temperature. Preferably, it has substantially the same ability to withstand variations in temperature as the glass of the baby's bottle 1, in particular when high temperatures are applied for the purposes of heating or of re-heating the baby's bottle 1 (microwave oven, double boiler or saucepan of water, baby's bottle heater, etc.), of sterilizing the baby's bottle, or of cleaning it in a dishwasher. In addition, this coating 8, like the glass of the baby's bottle 1, easily withstands particularly cold temperatures, e.g. while the baby's bottle 1 is being stored in a refrigerator.

In a preferred embodiment, said coating 8 has a thickness lying substantially in the range 0.1 millimeters (mm) to 5 mm, preferably lying substantially in the range 0.4 mm to 2 mm, and advantageously substantially equal to 1 mm. Such a thickness is sufficient for imparting anti-breakage properties to the baby's bottle 1.

Advantageously, said coating 8 is substantially transparent, i.e. it allows light to pass through it and the contents of the baby's bottle 1 can be seen through the coating 8. Preferably, the coating 8 has no particular hue and is substantially colorless. However, without going beyond the ambit of the present invention, it is quite possible for the coating 8 to have a particular color while also continuing to have its property of being transparent. It is also quite possible for the coating to be translucent, with or without any associated coloring, so as to make it possible to see only the level of the contents of the baby's bottle 1.

In another preferred embodiment, said coating 8 is substantially non-sticky to the touch, i.e. it has a pleasantly smooth and dry feel to it.

Silicone is preferably the majority ingredient of the coating 8, or indeed the sole component thereof. It is thus the silicone that imparts the properties of thermal resistance, of transparency, of adhesion to glass, of stability, of aesthetically pleasing appearance, and of non-sticky feel to the coating 8.

In addition, the coating 8 is fully stable chemically, regardless of its use, e.g. it does not leach out any of its ingredients, it is not degraded by contact with water or with steam, or by repeated contact with certain surfaces (tables, work surfaces, etc.), or with the hands of the user. The coating 8 thus preferably contains components that impart particularly high mechanical, chemical, and thermal resistance to it.

The coating 8 advantageously includes a silicone elastomer that has the above-described characteristics, in particular optimum viscosity, sufficient mechanical strength characteristics, transparency compatible with its use, ease of processing, and approval for contact with food.

In order to satisfy these various criteria, a bi-component Room Temperature Vulcanization (RTV) silicone is chosen that reacts at room temperature and that has components that react only after contact. Thus, a bi-component RTV silicone is easier to process than a mono-component RTV silicon elastomer in which vulcanization is activated by the humidity of the air.

Because of the viscosity and pot life constraints for forming a dipping bath for the baby's bottle 1, and for procuring all of the required properties as mentioned above, the silicone chosen for the coating 8 is RHODORSIL RTV 141®, sold by Bluestar Silicones.

This particular silicone (RHODORSIL RTV 141®) advantageously makes it possible to obtain all of the characteristics of the coating 8 of the baby's bottle 1 of the invention, so that said baby's bottle has mechanical properties, in particular anti-breakage properties, that are improved and considerably greater than those of a conventional baby's bottle made of uncoated glass. In addition, the combination of the above-mentioned particular type of glass for the glass wall 2 of the baby's bottle 1 and of the silicone-based coating 8 offers the advantage of making it possible to obtain a glass baby's bottle 1 that is particularly stable and resistant, both mechanically and chemically. The baby's bottle 1 covered with the coating 8 is, for example, resistant to high moisture levels (in a dishwasher), and to numerous impacts, such as, for example knocks and falls, and to thermal shock, this list not being exhaustive.

The baby's bottle 1 is also safe in terms of innocuousness and of toxicity, and its coating 8 is stable and remains in position on the baby's bottle 1 regardless of the use that is made of the bottle as a food container. Preferably, the silicone-based coating 8 withstands cold chemical sterilization, boiling water, dishwashing, microwaving, and autoclave sterilization (30 minutes under pressure at 121° C.) that is similar to sterilization in a pressure cooker.

It is also quite possible, without going beyond the ambit of the present invention, to use some other type of silicone that presents the required properties, e.g. a Liquid Silicone Rubber (LSR) silicone elastomer or an elastomer that can be hot-vulcanized.

The present invention also relates to a method of manufacturing a container 1 designed to contain at least one product, preferably a human or animal foodstuff. Said container 1 has a glass wall 2 made up of an inside face 3 designed to be in contact with said at least one product/foodstuff, and of an outside face 4 that is opposite from said inside face.

Advantageously, the container 1 is substantially identical to the above-described container. Indeed, the method preferably constitutes a method of manufacturing a baby's bottle 1 for feeding infants.

This method preferably includes a first step of supplying or of making said container 1, which has a body 5 that is advantageously made of glass. The glass of the container 1 preferably presents the above-described characteristics, in particular in terms of thermal and mechanical strength. The step of making the container 1 advantageously includes a sub-step of hot-treating the glass with metal oxide, which sub-step consists in applying a layer of metal oxide serving to harden the outside face 4 of the container 1. This sub-step is preferably followed by cold-treatment that consists in applying a lubricant layer, especially in view of protecting the container while being transported, and preventing scratches or fracture initiation cracks from occurring as the container is manipulated e.g. towards the pre-heating and/or dipping treatment stations.

After this supply step, the method of the invention includes a coating step of covering at least a fraction of said outside face 4 with a coating 8 including at least a silicone and serving to impart resistance-to-breakage properties to said glass wall 2. This coating step includes a dipping step during which the container 1 is inserted into and immersed in a dipping bath containing the silicone.

Preferably, the dipping step includes a step of preparing the dipping bath based on said silicone, during which step a substantially liquid bath is formed from a bi-component silicone having viscosity and pot life that are compatible with coating the glass outside face 4. In other words, the silicone is chosen for its flow properties, so as to facilitate coating the outside face 4 of the baby's bottle 1 with said silicone.

The step of preparing the silicone bath advantageously consists in mixing, e.g. in a dipping vessel provided for that purpose, a first mixture (portion A) based on polymethylvinylsiloxane and containing at least one catalyst, e.g. a platinum derivative, and a second mixture (portion B) based on polymethylvinylsiloxanes and on polymethylhydrogeno-siloxanes. Preferably, these components are obtained by using a particular silicone, e.g. the silicone RHODORSIL RTV 141® sold by Bluestar Silicones.

The first and second mixtures present respective viscosities at 25° C. of 3500 millipascal-seconds (mPa·S) and of 650 mPa·s, while the silicone bath obtained from these mixtures presents viscosity of about 4000 mPa·s at 25° C. and pot life of substantially 4 hours at the same temperature. Advantageously, such viscosity for the silicone bath guarantees effective, homogeneous and even coating of the outside face 4 of the baby's bottle 1.

Advantageously, vulcanized RHODORSIL RTV 141® has a Shore A hardness of 50, a tensile strength of 6 megapascals (MPa) and a breaking elongation of 120%. The pot life may advantageously be increased by decreasing the temperature of the bath, such a decrease also causing the initial viscosity of the silicone to increase. It is thus necessary to strike a compromise between these two parameters.

In particular, variation in the viscosity of RHODORSIL RTV 141® for temperatures ranging from −9° C. to 20° C. is expressed in the following table and in FIG. 2 that shows the values of the following table in graph form:

| Temperature | Brookfield |
|---|---|
| of the first | viscosity (3/5) |
| mixture in ° C. | in mPa · s |
| −9 | 10,720 |
| 4 | 7620 |
| 6 | 6850 |
| 9 | 6480 |
| 11 | 6000 |
| 15 | 5180 |
| 17 | 4980 |
| 20 | 4680 |

Thus, it can be seen that the viscosity of RHODORSIL RTV 141® increases substantially uniformly with decreasing temperature. However, it should also be noted that the increase in viscosity is moderate in a temperature range from 10° C. to 20° C. It is thus preferable to keep the silicone bath within this temperature range, so that its viscosity continues for as long as possible to have a value that is optimum for coating said baby's bottle 1.

In a preferred implementation, regulation of the temperature of the dipping bath at about 10° C. increases the initial viscosity of the silicone only moderately, said viscosity increasing from 4000 mPa·s to about 6000 mPa·s, but such regulation advantageously makes it possible to increase the pot life significantly to about ten hours, as shown in FIG. 3, whereas it is only 4 hours at room temperature.

By suitably choosing the regulation temperature of the dipping bath, a compromise can be stroke between on one hand a minimal admissible temperature value, which has to be sufficiently high to ensure that the initial viscosity of the mixture is low enough to be compatible with dip-coating the container 1, and, on the other hand, a maximal admissible temperature which has to be sufficiently low for slowing down the reticulation of the bath after the ingredients have been mixed, thereby slowing down the progressive increase of the viscosity over the time, so as to keep the bath useable as long as possible. Having the bath temperature decrease under the minimal value may cause a risk of “freezing” the mixture, while having said bath temperature increase over the maximal value may accelerate the reticulation process in the bath and consequently reduce the pot life.

Preferably, the first and second mixtures of the RHODORSIL RTV 141® are incorporated in the proportions recommended by the supplier, and in general the proportion of the mixture comprises 10 parts of the second mixture for 100 parts of the first mixture.

It is also quite possible, without going beyond the ambit of the present invention, for any other type of silicone to be used to obtain the required properties for the coating 8. In addition, it is possible for a particular implementation of the dipping bath based on silicone to include the addition of other components, e.g. dyes or odorant additives, with a view to imparting various aesthetically pleasing qualities to said baby's bottle 1. It is also quite possible to make provision to add curing inhibitors in order to increase pot life.

Both cooling the bath and using curing inhibitor, enables the pot life to be extended, e.g. beyond four hours, and possibly up to eight or twelve hours.

Vacuum degassing of the mixture is then necessary, prior to the dipping step, in order to remove any air bubbles introduced during homogenization of the mixture. This step is accompanied by an expansion in the volume of silicone by 4 to 5 times its initial volume.

The dipping bath is preferably fed continuously with the mixture so as to maintain a constant height of liquid silicone. It is preferably regulated at low temperature so as to slow down the vulcanization, thereby slowing down the increase of the viscosity. Preferably, the limit for dipping of the baby's bottle 1 lies just beneath the ring or the neck 6, so that the baby's bottle 1 is coated over its entire height for maximum effectiveness, in particular in terms of mechanical strength. Advantageously, the ring 6 is not coated with silicone, so as not to hinder fastening the teat onto the baby's bottle 1.

Vulcanization of the silicone takes place as soon as the first and second mixtures (portions A and B) of the RHODORSIL RTV 141® are put into contact with each other. The silicone preferably vulcanizes at room temperature by a polyaddition reaction that can be considerably accelerated by increasing its temperature. Thus, the higher the temperature, the shorter the total vulcanization time.

The time necessary for vulcanization has been determined at 120° C. and 150° C. by measuring the variation in Shore A hardness as a function of time, as shown in the table below. As indicated in the table, vulcanization of the silicone is substantially total after 20 minutes at 120° C. or after 5 minutes at 150° C. It is necessary to wait for complete vulcanization of the silicone on the glass, while controlling the baking temperature and time, so as to obtain a silicone that forms a unitary lattice with optimum mechanical properties.

In particular, the following tables indicate the progress of the vulcanization by measuring hardness of the silicone, expressed on the Shore A scale. The vulcanization is total when the hardness ceases to change.

Hardness as a function of time
for vulcanization at 120° C.:

| Time | Hardness |
|---|---|
| (minutes) | (Shore A) |
| 2 | NV¹ |
| 5 | 33 |
| 10 | 42 |
| 15 | 43 |
| 20 | 46 |
| 30 | 46 |

¹NV for “Non-Vulcanized”

Hardness as a function of time for
vulcanization at 150° C.:

| Time at | | Time at | | Breaking |
|---|---|---|---|---|
| 150° C. | Hardness | RT | Hardness | strength |
| (minutes) | (Shore A) | (hours) | (Shore A) | (N/mm²) |
| 2 | 37 | 15 | 37 | 0.62 |
| 5 | 45 | 15 | 45 | 6.87 |
| 10 | 45 | 15 | 47 | 6.36 |

The coating made from RHODORSIL RTV 141® is fully transparent. It has a slightly rubbery appearance and/or feel but it is advantageously non-sticky to the touch. This property of the coating 8 is related to the Shore A hardness of the dipping bath. Advantageously, the higher the Shore A hardness, the less sticky the feel.

Preferably, the dipping step includes a sub-step of causing said container 1 to penetrate into the bath based on silicone, during which sub-step the container 1, which is preferably a baby's bottle 1 in this example, is held stationary substantially in an inclined position while the silicone bath is caused to move in such a manner as to coat substantially the entire outside face 4 of said container 1. During this penetration step, the baby's bottle 1 is preferably held using tongs with its neck 6 facing upwards. The baby's bottle 1 is in a slightly inclined vertical position on penetrating into the bath, so as to enable the bottom 9 to be coated properly and to avoid runs. Preferably, the bath rises via a mechanical system, e.g. a cam having a shape that needs to be adapted as a function of the container 1 and of the characteristics of the bath. In advantageous manner, the baby's bottle 1 is straightened up into a substantially vertical position before the end of dipping, and preferably after the bottom 9 has been coated with the dipping bath.

In a particularly advantageous implementation, prior to the dipping step, the method includes a step of preheating said container 1, which is a baby's bottle 1 in this example.

Preferably, during the pre-heating step, the glass of the container 1, and more particularly the glass wall 2, or at last the portions of the outside face 4 to be coated, are brought to a temperature substantially lying in the range from 200° C. to 250° C., and preferably substantially in the range from 200° C. to 220° C.

To this end, a temperature substantially lying in the range from 400° C. to 600° C., and preferably substantially equal to 470° C., may be applied to the container 1 during the step of pre-heating. The temperature of the glass may thus rise to about 240° C., e.g. in the case of a baby bottle to be treated.

This preheating step advantageously makes it possible to facilitate keying of the silicone onto the glass outside face 4 of the baby's bottle 1 and to avoid runs.

Of course, the temperature applied to the container 1 during this preheating step may vary depending on the implementation of the present invention, e.g. as a function of the type of container 1 (size, dimensions, type of glass, etc.), of the number of containers 1 to be preheated, of the size of the preheating oven, etc., this list not being exhaustive.

By way of example, a lower temperature set value may be applied for bringing the glass to a temperature lying in the “lower” pre-heating range, such as 200° C.-220° C., so as to prevent previously existing container's decoration, e.g. decoration made by screen printing, from being damaged.

In any case, preheating makes it possible to have the pre-heated container 1 be hot-immersed, once substantially heated to 200° C.-220° C., or possibly up to 250° C., in a “cold” bath based on the silicone which is suitable for the coating 8, said bath being cooled so as to increase its lifetime.

The silicone bath is advantageously a “cold” bath, whose temperature is significantly lower than the temperature of the container which is dived into said bath, for instance by some tens or hundreds of degrees Celsius. Said bath is preferably cooled and regulated in such a manner that its average temperature is substantially maintained equal to or lower than 40° C., preferably lower than 35° C., 30° C. or 20° C., while being preferably equal to or greater than 10° C.

Thus the bath temperature may be held substantially in the range from 10° C. to 20° C., or at about 10° C., as mentioned above. It may be also acceptable to practically have the temperature be only in the vicinity of this range, thereby possibly using less-demanding or more energy-saving facilities, said temperature being substantially held in the range from 15° C. or 20° C. (lower value) to 30° C. or 35° C. (upper value).

Advantageously, the thermal gradient thus achieved between the glass to be coated and the silicone coming into contact with said glass enables the silicone to be “seared” on the hot surface of the container, and more particularly on the outside face 4, thereby promoting the local reticulation of a kind of even sub-layer, and the building of a global layer having an improved homogeneity and an even thickness, without runs effect.

Prior to dipping, the bottle 1 is preferably preheated to a temperature making it possible to form a coating 8 that is sufficiently thick to be effective in restraining any splinters of glass, in the event that repeated thermal shocks, mechanical impacts, or other abuse applied to the baby's bottle 1 cause its glass wall 4 to break. In addition, this step of preheating the glass wall 4 also advantageously makes it possible to limit the risks of runs on the outside face 4 of the baby's bottle 1.

In addition, should the outside face 4 be coated by a primer, prior to the pre-heating step, in view of finally increasing the anchorage of the silicone coating 8, as it may be suggested by the silicone supplier, then said pre-heating step may advantageously contribute to dry the primer coating, in a accelerated manner, before the silicone coating is achieved.

In addition, the speed at which the baby's bottle 1 is removed from the dipping bath is preferably controlled because said speed generally constitutes a parameter that is extremely important for the quality and uniformity of the coating 8. Advantageously, said speed must be preferably relatively high during removal of the top half of the baby's bottle 1. The speed of removal is then preferably slowed during removal of the bottom half of the baby's bottle 1, and more particularly towards the end when the bottom 9 of the baby's bottle 1 is coming close to the surface of the dipping bath, in order to limit runs. An example of a suitable speed profile is given, in particular, in FIG. 4.

By optimizing the preheating temperature of the glass and the machine settings (position of the container 1 at the at the time of the dipping, profile of the speed at which the dipping bath is raised), any runs are eliminated and a coating 8 is obtained that is homogeneous, in particular in terms of visual appearance and of feel.

In addition, after the dipping step, the method includes a step of heating said container 1, in such a manner as to enable said silicone to be totally vulcanized. Such total vulcanization guarantees that optimum mechanical properties are obtained for the silicone, resulting in good holding of the silicone on the glass and in distribution of the silicone in the form of a layer that is substantially homogeneous in appearance and/or in feel.

Preferably, the heating step comprises two successive heating cycles applied to said container 1 at a temperature substantially lying in the range 200° C. to 400° C., preferably substantially lying in the range 220° C. to 250° C., and preferably substantially equal to 243° C. and 225° C. respectively. The temperature applied to the container 1 during this heating step may also vary depending on the implementation of the present invention, preferably as a function of the same criteria as for above-mentioned preheating temperature.

Finally, after the heating step, the method includes a step of cooling said container 1 to a temperature substantially lying in the range 5° C. to 50° C., and preferably substantially lying in the range 10° C. to 30° C. The cooling step is preferably performed by applying a flow of cold air to the container 1, which goes through an air flow zone.

This forced cooling step, which may be achieved by blowing compressed air at an ambient or cooled temperature, advantageously makes it possible to accelerate the cooling of the container to a temperature which is compatible with the handling, possible filling or packaging of said container, thereby reducing the cycle time of the process and the intermediate storage of the containers 1 once they have been coated by silicone.

The method according to the invention thus advantageously makes it possible to obtain a coating 8 in one piece, without any runs, over the entire outside face 4 of the baby's bottle 1, in such a manner as to limit the risks of said baby's bottle breaking in the event of accidental falls and/or accidental impacts or shocks.

In addition, the inventions relates to a baby bottle as such, which is made of borosilicate glass or type I glass, whose glass body is coated with silicone, regardless of the coating process.

Some examples of tests performed using the method and the container 1 of the invention are described below.

### EXAMPLE 1

This was an anti-breakage test conducted using a baby's bottle 1 covered with a coating 8 based on RHODORSIL RTV 141® silicone as described above and obtained using the above-described method. This test was conducted on a baby's bottle made of type I glass and having a capacity of 158 milliliters (ml).

The baby's bottle 1 was preheated in an oven at a preheating temperature making it possible to obtain a glass temperature substantially lying in the range 200° C. to 250° C., and the thickness of the coating 8 was approximately in the range 1 mm to 1.5 mm, corresponding to a weight of about 20 grams (g) for this 158 ml baby's bottle.

In order to test the effectiveness of the coating 8, the baby's bottle 1 was filled with water, closed with a crimped rubber stopper, and then released from a height of about 2 meters (m) onto a concrete slab. The same test was conducted with a baby's bottle made of bare type I glass, having a capacity of 158 ml, and not having the coating 8 of the invention, the behavior of that bare glass bottle serving as a negative control for the anti-breakage test conducted on the coating 8 of the invention.

This test made it possible to assess simultaneously the restraint of the glass of the baby's bottle 1 and the restraint of the liquid that it contained. It was a test that was particularly representative for measuring the anti-breakage and restraint potential of a coating, even thought it did not make it possible to achieve optimum control of the zone and of the angle of impact.

Various tests were conducted with the two baby's bottles, one of which was a negative control and the other of which was covered with the coating 8. Those tests showed that the coating 8 procured good absorption of the impact induced by the drop. During the drop test, the baby's bottle 1 provided with the coating 8 of RHODORSIL RTV 141® silicone was merely cracked whereas the baby's bottle made of bare glass shattered.

The coated baby's bottle 1 was subjected to a second drop test in order to observe the quality of restraint under major breakage conditions. Very good restraint of the glass was observed, even though certain tears in the coating 8 were observed that might limit restraint of the liquid.

RHODORSIL RTV 141® silicone offers numerous advantages, in particular as regards the constraints related to the method of deposition by dipping and thus makes it possible to reduce the risks of breakage and of shattering of the baby's bottle 1, while also procuring good restraint of any fragments of glass.

### EXAMPLE 2

This example relates to a test for forming a coating 8 using dipping in a bath of RHODORSIL RTV 141® silicone, for a container 1 as described above. This test was conducted on a production line under conditions similar to industrial conditions. The differences compared with industrial production are as follows:
a reduced dipping bath volume (1 kilogram (kg) as against 35 kg) that was not topped up, thereby giving rise to a reduction in the filling level during the test and not making it possible to regenerate a dipping bath; and
a single container 1 per dipping rack that can conventionally contain up to 9 containers 1, thereby giving rise to a glass temperature during the preheating and the baking that were slightly higher than what they would be for a line fully loaded with containers 1.

The containers 1 of this test were flasks having glass of type III. The various steps of the method were as follows:
loading the flasks 1 that were held in vertical positions using tongs, their rings 6 facing upwards;
putting the flasks 1 in an oven for preheating the glass;
dipping the flasks 1 in a bath of silicone; the flasks 1 were stationary but inclined as they penetrated into the bath; the bath rises via a mechanical system which, in this example, was constituted by a cam having a shape adapted as a function of the flask 1 and of the characteristics of the bath;
turning the flasks 1 over putting them in an oven constituted by two heating zones, so as to make it possible to cure the silicone;
cooling the flasks 1 in an air flow zone; and
unloading and packaging the flasks 1.

For this test, the conditions that made it possible to obtain flasks 1 not having runs were as follows:
preheating temperature: 470° C., making it possible to obtain a flask temperature of about 240° C.;
baking temperature in the heating zone 1: 243° C.;
baking temperature in the heating zone 2: 225° C.; and
cycle time: 22 seconds for the dipping step, and 4 to 5 minutes in the oven on one hand for the pre-heating step, and substantially the same time on the other hand for the baking step in view of reticulating the silicone after the dipping step.

Optimizing the glass preheating temperature and the machine settings make it possible to eliminate any runs that might take place on turning the flask 1 over.

The coating was total and run-free, the thickness of the coating lying in the range 1 mm to 2 mm. In addition, since the necessary preheating temperature was very high (470° C.), it was absolutely essential to provide a system for cooling the dipping and feed vessels so as to extend the lifetime of the bath.

A breakage test was conducted with two flasks 1 manufactured using the above-described steps in comparison with a conventional flask 1 not covered with a coating 8. The flasks were dropped from a height of 2 m onto a concrete floor. It was observed that the silicone coating 8 absorbed the shock considerably because it was necessary to let the flask 1 covered with the coating 8 fall several times (4 to 8 times) before its glass wall 4 broke, whereas the bare glass flask broke as of the first or second fall. In addition, the restraint of the glass was excellent and no fragment escaped from the coating 8 which provided a particularly effective restraint function.

### EXAMPLE 3

This test consisted in measuring the transparency of a glass container 1 covered with a coating 8 of the invention and in comparing said transparency with the transparency of a container 1 made of bare glass (without any coating 8). This test was conducted firstly on a baby's bottle 1 made of type I glass covered with a coating 8 of RHODORSIL RTV 141® silicone (in comparison to the same baby's bottle 1 made of bare glass), and then on a flask 1 made of type III glass as in the example 2 and covered with a coating 8 of RHODORSIL RTV 141® silicone (in comparison to the same flask 1 made of bare glass).

The color or “hue” of the coating 8 of RHODORSIL RTV 141® silicone was measured by colorimetry using a Datacolor International colorimeter (Spectraflash SF 450). For that measurement, use was made of the L* a* b* color system that corresponds to a color representation model developed by the International Commission on Illumination (CIE) in 1976. Color is described using 3 values as shown in the diagram of FIG. 5 and on the basis of the following criteria L*, a*, and b*:
L*: lightness, that ranges from 0% (black) to 100% (white);
a*: component representing the red (128) to green (−128) range and going through white (0) if the lightness is 100%; and
b*: component representing the yellow (128) to blue (−128) range and going through white (0) if the lightness is 100%.

The measurement was taken in transmission, the illuminant used was D65, and the angle of observation was 10°. The following values were obtained:
for the bare baby's bottle 1: L*=89.62; a*=0.13; b=0.81;
for the baby's bottle 1 covered with the coating 8: L*=89.71; a*=−0.16; b=0.24;
for the bare flask 1: L*=91.68; a*=−0.11; b=0.88; and
for the flask 1 covered with the coating 8: L*=90.59; a*=0.09; b=1.71.

These values, in particular those for the parameter L*, made it possible to conclude that the baby's bottle 1 and the flask 1 covered with silicone in accordance with the invention had good transparency, close to the transparency of a bottle or of a flask made of bare glass. Thus, the coating 8 of the invention did not affect the transparency of the baby's bottle 1 or of the flask 1 and made it possible to see the contents thereof clearly.

These various tests made it possible to show the anti-breakage and restraint properties of the bottle 1 of the invention, and its transparency properties. The baby's bottle 1 of the invention is particularly strong and resistant to impacts and shocks, in particular in the event that it falls onto a hard floor.

1. A method of manufacturing a container (1) designed to contain at least one product, said container (1) having a glass well (2) made up of an inside face (3) designed to be in contact with said at least one product, and of an outside face (4) that is opposite from said inside face, said method being characterized in that it includes a coating step for covering at least a fraction of said outside face (4) with a coating (8) including at least a silicone and being designed to impart resistance-to-breakage properties to said glass wall (2), said coating step including a dipping step, said method further comprising, prior to the dipping step, a step of pre-heating the container (1).

2. The method of claim 1 wherein, during the pre-heating step, the glass of the container (1) is brought to a temperature substantially lying in the range from 200° C. to 250° C., and preferably substantially lying in the range from 200° C. to 220° C.

3. The method according to claim 1 wherein, during the dipping step, the pre-heated container 1 is hot-immersed in a cold bath based on the silicone, said bath being cooled so as to increase its lifetime.

4. The method according to claim 1, wherein during the dipping step, the pre-heated container 1 is hot-immersed in a cold bath based on the silicone, said bath being cooled in such a manner that its temperature is substantially maintained equal to or lower than 40° C., preferably lower than 35° C., 30° C. or 20° C., while being preferably equal to or greater than 10° C., and for example substantially in the range from 10° C. to 20° C., or at about 10° C., or in the range from 20° C. to 35° C.

5. The method according to claim 1, characterized in that the dipping step includes a step of preparing a bath based on said silicone, during which step a substantially liquid bath is formed from a bi-component silicone having a viscosity and a pot life that are compatible with coating said glass outside face (4).

6. The method according to claim 6, characterized in that the step of preparing the silicone bath consists in mixing a first mixture based on polymethylvinylsiloxane, and a second mixture based on polymethylvinylsiloxanes and on polymethylhydrogenosiloxanes.

7. The method according to claim 7, characterized in that the first and second mixtures present respective viscosities at 25° C. of 3500 mPa·s and of 650 mPa·s, while the silicone bath obtained from these mixtures presents a viscosity of about 4000 mPa·s at 25° C. and a pot life of substantially 4 hours at the same temperature.

8. The method according to claim 1, characterized in that the dipping step includes a sub-step of causing said container (1) to penetrate into the silicone-based bath, during which sub-step the container (1) is held stationary substantially in an inclined position while the silicone bath is caused to move in such a manner as to coat substantially the entire outside face (4) of said container (1).

9. The method according to claim 1, characterized in that, after the dipping step, the method includes a step of heating said container (1), in such a manner as to enable said silicone to be vulcanized.

10. The method according to claim 9, characterized in that the heating step comprises two successive heating cycles applied to said container (1) at a temperature substantially lying in the range 200° C. to 400° C., preferably substantially lying in the range 220° C. to 250° C., and preferably substantially equal to 243° C. and 225° C. respectively.

11. The method according to claim 9, characterized in that, after the heating step, the method includes a step of forced-cooling said container (1) to a temperature substantially lying in the range 5° C. to 50° C., and preferably substantially lying in the range 10° C. to 30° C., preferably performed by applying a flow of cold air to the container (1).

12. The method according to claim 1, characterized in that it constitutes a method of manufacturing a container (1) designed to contain at least one human or animal foodstuff, such as a baby's bottle (1) for feeding infants.

13. A container (1), such as a baby's bottle, resulting from the manufacturing method of claim 1.

14. The container (1) according to claim 13, characterized in that said coating (8) coats substantially the entire outside face (4) of said container (1).

15. The container (1) according to claim 13, characterized in that said coating (8) is designed to withstand temperatures that can vary over a range lying substantially from −20° C. to 100° C., and preferably over a range lying substantially from −10° C. to 95° C.

16. A container (1) according to claim 13, characterized in that said coating (8) has a thickness lying substantially in the range 0.1 mm to 5 mm, preferably lying substantially in the range 0.4 mm to 2 mm, and advantageously substantially equal to 1 mm.

17. A container (1) according to claim 13, characterized in that said coating (8) is substantially transparent.

18. A container (1) according to claim 13, characterized in that said coating (8) is substantially non-sticky to the touch.

19. A container (1) according to claim 13, characterized in that said wall (2) comprises a glass that is neutral through to its core and that is suitable for being in contact with food, preferably a type I glass.

20. The container (1) according to claim 14, characterized in that said coating (8) is designed to withstand temperatures that can vary over a range lying substantially from −20° C. to 100° C., and preferably over a range lying substantially from −10° C. to 95° C.
